(19) United States
(12) Patent Application Publication
(10) Pub. No.: US 2025/0327652 A1
(43) Pub. Date: Oct. 23, 2025

(54) FLEXIBLE MINIATURE STRAIN SENSORS BASED ON HELIX STRUCTURES AND THEIR SCALABLE FABRICATION

(71) Applicants: VIRGINIA TECH INTELLECTUAL PROPERTIES, INC., Blacksburg, VA (US); ADVANCED FUNCTIONAL FABRICS OF AMERICA, INC., Cambridge, MA (US)

(72) Inventors: Tong Qiu, Cambridge, MA (US); Ruixuan Wang, Blacksburg, VA (US); Anbo Wang, Blacksburg, VA (US); Xiaoting Jia, Blacksburg, VA (US); Alexander Stolyarov, Westford, MA (US); Michael Rein, Boston, MA (US)

(21) Appl. No.: 18/870,959

(22) PCT Filed: Apr. 3, 2023
(86) PCT No.: PCT/US2023/065281

§ 371 Date: Dec. 2, 2024

Related U.S. Application Data
(60) Provisional application No. 63/365,814, filed on Jun. 3, 2022.

(51) Int. Cl. G01B 7/16; G01B 7/24

(52) U.S. Cl. CPC G01B 7/22; G01B 7/24

(57) ABSTRACT

Flexible and scalable miniature capacitive and inductive strain sensors, as well as methods for fabricating such strain sensors are described herein. According to an example, a flexible capacitive strain sensor can include a stretchable center core and two parallel wires wound about the stretchable center core, forming a double helix structure. Each of the two parallel wires can be embodied as an insulated or an uninsulated copper wire and the stretchable center core can be embodied as a polyester elastic string. The two parallel wires can be wrapped around the stretchable center core in a gapless fashion and with a winding angle of less than 45 degrees with respect to the stretchable center core.

### CROSS-REFERENCE TO RELATED APPLICATION

This application claims the benefit of and priority to U.S. Provisional Patent Application No. 63/365,814, titled “Flexible Miniature Strain Sensors Based on Helix Structures and Their Scalable Fabrication,” filed Jun. 3, 2022, the entire contents of which is hereby incorporated by reference herein.

### GOVERNMENT LICENSE RIGHTS

This invention was made with U.S. Government support under Agreement No. W15QKN-16-3-001 awarded by the Army Contracting Command-New Jersey (ACC-NJ). The government has certain rights in the invention.

### BACKGROUND

Flexible strain sensors are used in numerous fields, such as healthcare monitoring, human-machine interfaces, soft robotics, and smart textiles, among others. Flexible strain sensors can be embedded or braided into various materials or structures, such as fabrics, ropes, and cables, among others. Such sensors typically consist of conductive elements that are incorporated into stretchable matrices, coated on existing fabrics, or are self-supporting. To improve the performance, some of such sensors may use conductive materials, such as carbon-based fibers and liquid conductors.

### SUMMARY

The present disclosure relates to flexible and scalable miniature strain sensors and methods for fabricating such strain sensors. More specifically, described herein are flexible and scalable miniature capacitive and inductive strain sensors, as well as methods for fabricating such strain sensors.

The strain sensors described herein can include a center stretchable core having one or two conductive wires wrapped around the center stretchable core to form a single or double helix structure, respectively. A strain sensor of the present disclosure that has a single conductive wire wrapped around the center stretchable core to form a single helix structure can function as an inductive strain sensor. Additionally, a strain sensor of the present disclosure that has two conductive wires wrapped around the center stretchable core to form a double helix structure can function as a capacitive strain sensor. Example applications for the strain sensors described herein can include life safety rope strain sensing, smart clothing strain sensing, and structural health monitoring.

According to an example, a flexible reactive strain sensor can include a stretchable center core and at least one wire wound about the stretchable center core, forming a helix structure. The wires can be wrapped around the stretchable center core in a gapless fashion and with a winding angle of less than 45 degrees with respect to the stretchable center core.

According to an example, a flexible capacitive strain sensor can include a stretchable center core and two parallel wires wound about the stretchable center core, forming a double helix structure. Each of the two parallel wires can be embodied as an insulated or an uninsulated copper wire and the stretchable center core can be embodied as a polyester elastic string. The two parallel wires can be wrapped around the stretchable center core in a gapless fashion and with a winding angle of less than 45 degrees with respect to the stretchable center core.

According to another example, a flexible inductive strain sensor can include a stretchable center core and a single wire wound about the stretchable center core, forming a single helix structure. The single wire can be embodied as an insulated or an uninsulated copper wire and the stretchable center core can be embodied as a polyester elastic string. The single wire can be wrapped around the stretchable center core in a gapless fashion such that a gap is not formed between any helical turns of the single wire. Additionally, the single wire can be wrapped around the stretchable center core with a winding angle of less than 45 degrees with respect to the stretchable center core.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a diagram of an example strain sensor system according to at least one embodiment of the present disclosure.

FIG. 2 illustrates a diagram of another example strain sensor system according to at least one embodiment of the present disclosure.

FIG. 3A illustrates a side view of an example fabrication system according to at least one embodiment of the present disclosure.

FIG. 3B illustrates a top view of the example fabrication system of FIG. 3A according to at least one embodiment of the present disclosure.

FIG. 4 illustrates another example fabrication system according to at least one embodiment of the present disclosure.

FIG. 5 illustrates a block diagram of an example computing device according to at least one embodiment of the present disclosure.

FIG. 6 illustrates a flow diagram of an example computer-implemented method that can be implemented to fabricate a strain sensor according to at least one embodiment of the present disclosure.

### DETAILED DESCRIPTION

As described above, miniature flexible strain sensors can be embedded or braided into various materials or structures, such as fabrics, ropes, and cables, among others. Such sensors typically consist of conductive elements that are incorporated into stretchable matrices, coated on existing fabrics, or are self-supporting.

An example of a miniature flexible strain sensor is a resistive strain sensor that detect and measure an induced strain through a variation of resistance caused by a geometry change, piezoresistive behavior, or both. However, a problem with such resistive strain sensors is that they often suffer from hysteresis, which can significantly degrade the sensor's performance. To overcome this limitation, capacitive strain sensors can be used.

A capacitive strain sensor is another example of a miniature flexible strain sensor that uses two conductors, whose separation and/or overlapping area can vary in response to an induced strain, thereby causing a change in capacitance associated with the two conductors. To achieve flexibility, some capacitive strain sensors use “soft” conductors, such as liquid metals and ionic liquids. The two conductor elements of a capacitive strain sensor can be placed coaxially or in parallel. In capacitive strain sensors that use solid metals as conductors, flexibility can be realized through a double helix structure. However, a problem with capacitive strain sensors is that they can require complex fabrication routes, especially those with liquid conductors. Additionally, capacitive strain sensos having the double helix structure with a silver coating or with ionic silver absorbed by stretchable fibers can lack durability and length scalability.

The present disclosure provides solutions to address the above-described problems associated with miniature flexible strain sensors in general and with respect to the existing strain sensors described above. To overcome such limitations, various examples of the present disclosure describe the fabrication and characterization of a flexible and scalable miniature capacitive strain sensor based on a double helix structure that can be formed by winding two parallel insulated or uninsulated copper wires around the stretchable core. In addition, various examples of the present disclosure describe the fabrication and characterization of a flexible and scalable miniature inductive strain sensor based on a single helix structure that can be formed by winding one insulated or uninsulated copper wire around the stretchable core.

The strain sensors of the present disclosure provide several technical benefits and advantages. For example, the strain sensors of the present disclosure exhibit negligible hysteresis, real-time response, simplicity in design and fabrication, tunable sensitivity, and scalable strain sensor length. In addition, the response of the strain sensors described herein is independent of an applied strain rate. Further, the strain sensors of the present disclosure allow for the use of a rich variety of fabrication materials and sensor dimensions, thereby providing for improved tunable sensitivity compared to existing flexible miniature strain sensors. Various examples of the strain sensors described herein can find immediate applications in, for instance, safety rope strain sensing, smart textile strain sensing, and structural health monitoring. In testing, the sensors described herein exhibit negligible hysteresis, with high repeatability. The sensors have been shown to have the ability to sense strain below 0.1%, independent of the strain rate, and less than a 100 mS response time.

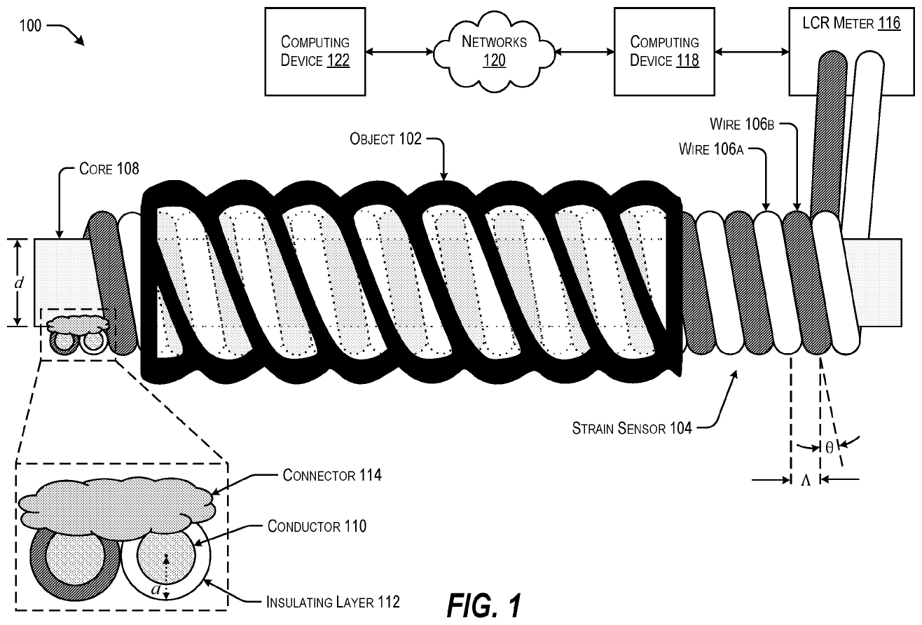

For context, FIG. 1 illustrates a diagram of an example strain sensor system 100 according to at least one embodiment of the present disclosure. The strain sensor system 100 can be embodied or implemented as a capacitive strain sensor system that can detect and measure the strain induced in an object based on a change in capacitance associated with a capacitive strain sensor of the capacitive strain sensor system. The change in capacitance can be detected and measured by an inductance, capacitance, and resistance meter (LCR meter), a computing device, or both.

In one example, the strain sensor system 100 can be embodied or implemented as an offline capacitive strain sensor system in which a capacitive strain sensor can be used to detect and measure the strain induced in an object as a result of a force being applied to the object. However, the present disclosure is not limited to such an offline system. In other examples, the strain sensor system 100 can be embodied or implemented as an online, real-time, online and offline hybrid, or near real-time capacitive strain sensor system in which a capacitive strain sensor can be used to detect and measure such strain induced in an object in real-time or near real-time.

As illustrated in the example depicted in FIG. 1, the strain sensor system 100 can include an object 102 that can include or be coupled (e.g., physically, operatively) to a strain sensor 104. In this example, the object 102 can be embodied and implemented as a rope or a cable and the strain sensor 104 can be embedded or woven into the object 102. However, the object 102 can be embodied or implemented as any type of structure or material that can include or be coupled to the strain sensor 104. For instance, the object 102 can be embodied or implemented as a textile or a textile component, such as a fabric, clothing, yarn, thread, string, or any combination thereof that can include or be coupled to the strain sensor 104. The strain sensor 104 can be coupled or incorporated into the object 102 in a variety of ways, such as woven into the object 102, affixed to the object 102 using ties, adhesives, or other affixing means, or otherwise secured to the object 102. In FIG. 1, both the sizes, shapes, and relative positions of the object 102 and the strain sensor 104 are illustrated as a representative example. The sizes, shapes, and relative positions of the object 102 and the strain sensor 104 can vary as compared to that shown in practice.

In the example depicted in FIG. 1, the strain sensor 104 can be embodied or implemented as a capacitive strain sensor. The strain sensor 104 includes two wires 106a, 106b and a central core 108. The wires 106a, 106b are wrapped around the core 108. Each of the wires 106a, 106b is wrapped around the core 108 in a helix pattern such that the wires 106a, 106b collectively form a double helix structure around the core 108. For example, the wires 106a, 106b can be wrapped around the core 108 such that the wires 106a, 106b are parallel to one another and form a double helix pattern around the core 108. Additionally, as shown in FIG. 1, the wires 106a, 106b can be wrapped around the core 108 such that a gap is not formed between the wires 106a, 106b. In some cases, the wires 106a, 106b can be wrapped around the core 108 such that a gap is formed between the wires 106a, 106b.

As illustrated in FIG. 1, the distance between a helical turn of the wire 106a and a helical turn of the wire 106b is denoted as Λ. This distance Λ is referred to herein as a “winding pitch Λ.” In addition, the angle between a vertical cross-section of the core 108 (i.e., taken in a plane that is perpendicular to a longitudinal axis of the core 108) and a helical turn of at least one of the wires 106a, 106b is denoted as θ. This angle θ is referred to herein as a “winding angle θ.” In the example depicted in FIG. 1, only a single winding pitch Λ and a single winding angle θ are denoted for clarity. The winding pitch/and the winding angle θ can characterize one or more properties of the strain sensor 104 such as, for instance, at least one of a mechanical characteristic, an electrical characteristic, or another characteristic. As such, during fabrication of the strain sensor 104, one or both of these parameters can be defined, maintained, and/or altered to achieve various desired goals associated with various applications of the strain sensor 104.

In some cases, the winding pitch Λ can be minimized to provide relatively improved sensor resolution for the strain sensor 104. In one example, the winding angle θ can be less than 45 degrees (°), although a range of winding angles θ between 15-60° may be relied upon. Particularly for winding angles θ of less than 45°, the capacitance between neighboring helical turns of the wires 106a, 106b can be dominant and the capacitance between facing helical turns of the wires 106a, 106b can be negligible. In examples where the winding angle θ is less than 45°, the strain sensitivity of the strain sensor 104 can be enhanced.

Each of the wires 106a, 106b can be embodied as an electrically conductive wire. In some cases, each of the wires 106a, 106b can be embodied as an electrically conductive wire having an insulating layer disposed around an electrically conductive wire element. In other cases, the insulating layer can be omitted such that each of the wires 106a, 106b can be embodied as an electrically conductive wire without an insulating layer. In some cases, the wire 106a can be embodied as an electrically conductive wire having an insulating layer disposed around an electrically conductive wire element and the wire 106b can be embodied as an electrically conductive wire without an insulating layer, or vice versa. Examples of the wires 106a, 106b can include a copper wire, an insulated copper wire, or another insulated or uninsulated electrically conductive wire. In the example illustrated in FIG. 1, each of the wires 106a, 106b can be embodied as an insulated electrically conductive wire having a conductor 110 wrapped in an insulating layer 112. The conductor 110 can be formed with, for instance, copper (Cu) and the insulating layer 112 can be formed with, for example, polyethylene (PE), although other conductors and insulators can be relied upon.

Each of the wires 106a, 106b can have a radius a, however, only a single radius a is denoted in FIG. 1 for clarity. The radius a of each of the wires 106a, 106b can vary depending on the application. In some cases, the radius a of each of the wires 106a, 106b can be the same. In other cases, the radius a of each of the wires 106a, 106b can be different. In one example, the wires 106a, 106b can each be embodied as an insulated copper wire having an American Wire Gauge (AWG) value of 34 and a radius a of 80 micrometers (μm), and thus, a diameter of 160 μm. The wires 106a, 106b can also have AWG values between 30-38, in other examples, and smaller or larger gauges can be relied upon in some cases. In addition, the wires 106a, 106b can extend to various lengths in the strain sensor 104 depending on the application. For instance, in a textile application or a safety rope application, the wires 106a, 106b can each extend to a length of approximately 40-50 centimeters (cm).

The core 108 can be embodied or implemented as a stretchable material at the center of the strain sensor 104. As examples, the core 108 can be embodied as an elastic material, such as a polyester elastic material, a polyester elastic string, an elastic crystal string, or other elastic or stretchable core material. As illustrated in FIG. 1, the core 108 can have a diameter d. The diameter d of the core 108 can vary depending on the application. In one example, the core 108 can have a diameter d of 1 millimeter (mm). The diameter d of the core 108 can range in other examples, such as between 0.5-3 mm, including every diameter between 0.5 to 3 mm in increments of 0.1 mm, and larger or smaller diameters can be relied upon in some cases. Additionally, the core 108 can extend to various lengths depending on the application. For instance, in a textile application or a safety rope application, the core 108 can extend to a length of between 25-35 cm. In other examples, the core 108 can extend to a length of between 5-10 cm, between 10-15 cm, between 15-20 cm, between 20-25 cm, between 25-30 cm, between 30-35 cm, between 35-40 cm, between 40-45 cm, or between 45-50 cm, and other lengths can be used. Overall, the lengths of the wires 106a, 106b can depend on the length of the core 108.

One end of each of the wires 106a, 106b can be coupled to the core 108 by a connector 114. The connector 114 can be embodied as an adhesive in one example. For instance, the connector 114 can be a cyanoacrylate-based adhesive. Although the connector 114 is depicted as an adhesive in FIG. 1, in some cases, the connector 114 can be embodied as any type of connector or fastener component or material that can be used to couple each of the wires 106a, 106b to the core 108. The connector 114 can be relied upon to secure one end of each of the wires 106a, 106b to the core 108 before the wires 106a, 106b are wound around the core 108. In some cases, another connector similar to the connector 114 can be relied upon to secure the distal end of each of the wires 106a, 106b to the core 108 after the wires 106a, 106b are wound around the core 108. It is not necessary in all cases for the wires 106a, 106b to be secured to the core 108 along the full length of the core 108 using an adhesive, such as the connector 114. Instead, the wires 106a, 106b are wrapped around and may contact the core 108, but the wires 106a, 106b may move (e.g., slide, shift, or expand) around the core 108 to some extent if the strain sensor 104 is subject to external stresses.

Due to the stretchable and bendable nature of the core 108, as well as the bendable or pliable characteristics of the wires 106a, 106b, the strain sensor 104 many change or vary to some extent in direction (e.g., path of extension), size (e.g., length), shape, or related structural characteristics when external forces act upon the strain sensor 104, either directly or in connection with the object 102. As described below, changes to the structural characteristics of the strain sensor 104 will impart a change in the capacitance of the strain sensor 104. These changes in the strain sensor 104 can be correlated to an amount of stress or strain applied to the strain sensor 104 and used in a range of sensory applications.

As illustrated in the example depicted in FIG. 1, the strain sensor system 100 can further include an LCR meter 116 and computing devices 118, 122. The LCR meter 116 can be embodied as any circuits or circuitry capable of or configured to measure at least one of inductance, capacitance, or resistance, or some combination thereof. The LCR meter 116 can be coupled (e.g., electrically coupled) to the strain sensor 104 by way of the wires 106a, 106b. Particularly, one end of each the wires 106a, 106b (e.g., the same near or far end) can be stripped of the insulating layer 112 and electrically coupled to input terminals of the LCR meter 116. The LCR meter 116 can also be coupled (e.g., communicatively, electrically, operatively) to the computing device 118. Additionally, the computing device 118 can be coupled to (e.g., communicatively, operatively) the computing device 122 by way of one or more networks 120 (hereinafter, “the networks 120”).

The LCR meter 116 can detect and measure a change in capacitance associated with the wires 106a, 106b that can be caused by movement of the wires 106a, 106b relative to one another. For instance, the LCR meter 116 can apply an electrical signal to the wires 106a, 106b while at least one of the object 102 or the strain sensor 104 is being moved in any direction or is otherwise subjected to external forces. As the object 102 and/or the strain sensor 104 moves, at least one of the winding pitch/or the winding angle θ corresponding to one or more sections of the wires 106a, 106b can change along at least some length of the strain sensor 104. Such a change in at least one of the winding pitch Λ or the winding angle θ over one or more sections or lengths of the wires 106a, 106b can alter the capacitance associated with the wires 106a, 106b. This capacitance change can be detected and measured by the LCR meter 116. Further, this capacitance change can correlate with and correspond to the extent of strain induced in at least one of the strain sensor 104 or the object 102 as a result of the movement of the strain sensor 104 and/or the object 102. More specifically, the strain can be a function of the capacitance change that can be associated with the wires 106a, 106b as a result of moving at least one of the object 102 or the strain sensor 104. In one example, to detect and measure the capacitance associated with the wires 106a, 106b, the LCR meter 116 can be set to an alternating sense frequency of 100 kilohertz (kHz), although the change in capacitance can be measured or characterized at other frequencies.

After detecting and measuring the above-described capacitance change associated with the strain sensor 104, the LCR meter 116 can provide capacitance change data to the computing device 118. The capacitance change data can be indicative of the above-described capacitance change that can be associated with the wires 106a, 106b as a result of moving at least one of the object 102 or the strain sensor 104. The computing device 118 can use the capacitance change data to compute a corresponding strain value that can be indicative of and correspond to the strain induced in at least one of the strain sensor 104 or the object 102 as a result of the movement or forces applied. It should be appreciated that the change in capacitance of the strain sensor 104 can be independent of but correlated to a strain induced in at least one of the object 102 or the strain sensor 104 as a result of moving one or both of such components.

The computing device 118 can be embodied or implemented as, for example, a client computing device, a peripheral computing device, or both. The computing device 118, while described in the singular, may include a collection of computing devices 118. Examples of the computing device 118 can include at least one of a computer, a general-purpose computer, a special-purpose computer, a laptop, a tablet, a smartphone, or another client computing device.

In some cases, the computing device 118 can perform one or more operations based on at least one of the above-described capacitance change data or the corresponding strain value that can be obtained and computed by the computing device 118, respectively. In one example, the computing device 118 can monitor capacitance change data provided by the LCR meter 116 that can be associated with the wires 106a, 106b as the object 102 and/or the strain sensor 104 move over time. The computing device 118 can further use such capacitance change data to compute and monitor corresponding strains induced in at least one of the object 102 or the strain sensor 104 as a result of such movement over time. If the computing device 118 determines that one or more strain values induced in at least one of the object 102 or the strain sensor 104 exceed a defined strain threshold, the computing device 118 can, for instance, provide a warning notification. In one example, the computing device 118 can provide such a warning notification by using one or more output devices that can be included in or coupled (e.g., communicatively, electrically, operatively) to the computing device 118. Examples of such output devices can include at least one of a display device, a light source, a speaker, a haptic output devices (e.g., a device configured to generate vibratory output), or another output device.

Although not illustrated in FIG. 1, in some cases, the strain sensor system 100 can include multiple strain sensors 104 that can be separately positioned at various locations along and/or around the object 102. Any or all of such strain sensors 104 can include a set of wires 106a, 106b wrapped in a double helix pattern around a respective core 108. Additionally, any or all of such strain sensors 104 can be coupled (e.g., communicatively, electrically, operatively) to at least one of the LCR meter 116, another LCR meter, or the computing device 118. Further, the LCR meter 116 can detect and measure respective capacitance change data corresponding to any or all of such strain sensors 104 for a section or area of the object 102 in which they are respectively disposed. In this way, the strain sensor system 100 can facilitate monitoring of, for instance, the structural and mechanical integrity of the object 102 based on various capacitance change data corresponding to any or all of the strain sensors 104. The strain sensor system 100 can thereby allow for a warning notification to be issued prior to failure of the object 102 due to stain values induced on the object 102 that exceed its strain limits.

In some examples, the computing device 118 can implement a model such as, for instance, a machine learning (ML) model, an artificial intelligence (AI) model, or another model to determine a current state of the object 102 or to predict when the object 102 may potentially fail (e.g., rupture). For instance, the computing device 118 can implement such a model to determine the current mechanical or structural integrity of the object 102 based on at least one of the above-described capacitance change data or corresponding strain values that can be obtained and computed by the computing device 118, respectively, based at least in part on data or readings from the LCR meter 116. In another example, the computing device 118 can implement at least one of an ML model, an AI model, or another model to predict the future mechanical or structural integrity of the object 102 based on at least one of such capacitance change data or corresponding strain values. In this way, the computing device 118 can predict when the object 102 may potentially rupture.

In some cases, the computing device 118 can provide at least one of the above-described capacitance change data, corresponding strain values, or warning notification to the computing device 122 by way of the networks 120. The computing device 122 can be embodied or implemented as, for instance, a server computing device, a virtual machine, a supercomputer, a quantum computer or processor, another type of computing device, or any combination thereof. Alternatively, in some examples, the computing device 122 can be embodied or implemented as a client or peripheral computing device such as, for instance, a computer, a general-purpose computer, a special-purpose computer, a laptop, a tablet, a smartphone, another client computing device, or any combination thereof. The computing device 122, while described in the singular, may include a collection of computing devices 122.

The computing device 122 can implement one or more aspects of the present disclosure. For example, in some cases, the computing device 118 can offload at least some of its processing workload to the computing device 122 via the networks 120. In one example, the computing device 118 can use the networks 120 to send the computing device 122 the above-described capacitance change data that can be associated with the wires 106a, 106b as a result of the object 102 and/or the strain sensor 104 moving over time. The computing device 122 can then use such capacitance change data to compute and monitor corresponding strains induced in at least one of the object 102 or the strain sensor 104 as a result of such movement over time. If the computing device 122 determines that one or more strain values induced in at least one of the object 102 or the strain sensor 104 exceed a defined strain threshold, the computing device 122 can, for instance, provide the warning notification described above. In one example, the computing device 122 can provide such a warning notification by using one or more output devices that can be included in or coupled (e.g., communicatively, electrically, operatively) to the computing device 122. Examples of such output devices can include at least one of a display device, a light source, a speaker, a haptic output devices (e.g., a device configured to generate vibratory output), or another output device.

In another example, the computing device 118 can use the networks 120 to send the computing device 122 at least one of the above-described capacitance change data or corresponding strain values that can be obtained and computed by the computing device 118, respectively. The computing device 122 can then use such capacitance change data and/or corresponding strain values to implement a model such as, for instance, an ML model, an AI model, or another model to determine a current state of the object 102 or to predict when the object 102 may potentially fail (e.g., rupture). For instance, the computing device 122 can implement such a model to determine the current mechanical or structural integrity of the object 102 based on such capacitance change data and/or corresponding strain values. In another example, the computing device 122 can implement at least one of an ML model, an AI model, or another model to predict the future mechanical or structural integrity of the object 102 based on at least one of such capacitance change data or corresponding strain values. In this way, the computing device 122 can predict when the object 102 may potentially rupture.

The networks 120 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The object 102 and the computing device 122 can communicate data with one another over the networks 120 using any suitable systems interconnect models and/or protocols. Example interconnect models and protocols can include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 120, without limitation. Although not illustrated, the networks 120 can also include connections to any number of other network hosts, such as website servers, file servers, networked computing resources, databases, data stores, or other network or computing architectures in some cases.

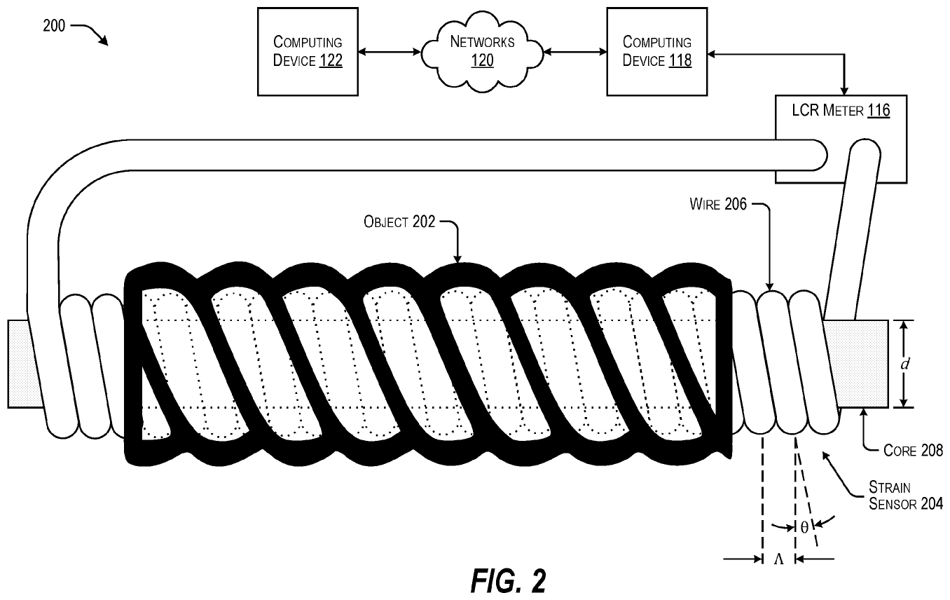

FIG. 2 illustrates a diagram of another example strain sensor system 200 according to at least one embodiment of the present disclosure. The strain sensor system 200 can be embodied or implemented as an inductive strain sensor system that can detect and measure the strain induced in an object based on a change in inductance associated with an inductive strain sensor of the inductive strain sensor system. The change in inductance can be detected and measured by an LCR meter, a computing device, or both.

In one example, the strain sensor system 200 can be embodied or implemented as an offline inductive strain sensor system in which an inductive strain sensor can be used to detect and measure the strain induced in an object as a result of a force being applied to the object. However, the present disclosure is not limited to such an offline system. In other examples, the strain sensor system 200 can be embodied or implemented as an online, real-time, online and offline hybrid, or near real-time inductive strain sensor system in which an inductive strain sensor can be used to detect and measure such strain induced in an object in real-time or near real-time.

As illustrated in the example depicted in FIG. 2, the strain sensor system 200 can include an object 202 that can include or be coupled (e.g., physically, operatively) to a strain sensor 204. In this example, the object 202 can be embodied and implemented as a rope or a cable and the strain sensor 204 can be embedded or woven into the object 202. However, the object 202 can be embodied or implemented as any type of structure or material that can include or be coupled to the strain sensor 204. For instance, the object 202 can be embodied or implemented as a textile or a textile component, such as a fabric, clothing, yarn, thread, string, or any combination thereof that can include or be coupled to the strain sensor 204. The strain sensor 204 can be coupled or incorporated into the object 202 in a variety of ways, such as woven into the object 202, affixed to the object 202 using ties, adhesives, or other affixing means, or otherwise secured to the object 202. In FIG. 2, both the sizes, shapes, and relative positions of the object 202 and the strain sensor 204 are illustrated as a representative example. The sizes, shapes, and relative positions of the object 202 and the strain sensor 204 can vary as compared to that shown in practice.

In the example depicted in FIG. 2, the strain sensor 204 can be embodied or implemented as an inductive strain sensor. The strain sensor 204 includes a wire 206 and a central core 308. The wire 206 is wrapped around the core 208 in a helix pattern such that the wire 206 forms a helix pattern or structure around the core 208. Additionally, the wire 206 can be wrapped around the core 208 such that a gap is not formed between any helical turns of the wire 206. In some cases, the wire 206 can be wrapped around the core 208 such that one or more gaps are formed between two or more helical turns of the wire 206.

As illustrated in FIG. 2, the distance between two helical turns of the wire 206 is denoted as Λ. This distance/is referred to herein as a “winding pitch Λ.” In addition, the angle between a vertical cross-section of the core 208 and a helical turn of the wire 206 is denoted as θ. This angle θ is referred to herein as a “winding angle θ.” In the example depicted in FIG. 2, only a single winding pitch Λ and a single winding angle θ are denoted for clarity. The winding pitch Λ and the winding angle θ can characterize one or more properties of the strain sensor 204 such as, for instance, at least one of a mechanical characteristic, an electrical characteristic, or another characteristic. As such, during fabrication of the strain sensor 204, one or both of these parameters can be defined, maintained, and/or altered to achieve various desired goals associated with various applications of the strain sensor 204.

In some cases, the winding pitch Λ can be minimized to provide relatively improved sensor resolution for the strain sensor 204. In one example, the winding angle θ can be less than 45°, although a range of winding angles θ between 15-60° may be relied upon. Particularly for winding angles θ of less than 45°, the capacitance between neighboring helical turns of the wire 206 can be dominant and the capacitance between facing helical turns of the wire 206 can be negligible. In examples where the winding angle θ is less than 45°, the strain sensitivity of the strain sensor 204 can be enhanced.

The wire 206 can be embodied as an electrically conductive wire. In some cases, the wire 206 can be embodied as an electrically conductive wire having an insulating layer disposed around an electrically conductive wire element. In other cases, the insulating layer can be omitted such that the wire 206 can be embodied as an electrically conductive wire without an insulating layer. Examples of the wire 206 can include a copper wire, an insulated copper wire, or another insulated or uninsulated electrically conductive wire. In the example illustrated in FIG. 2, the wire 206 can be embodied as an insulated electrically conductive wire. For instance, although not depicted in FIG. 2 for clarity, the wire 206 can be embodied as an insulated electrically conductive wire having a conductor wrapped in an insulating layer. The conductor can be formed with, for instance, copper (Cu) and the insulating layer can be formed with, for example, polyethylene (PE).

The wire 206 can have a radius a that can vary depending on the application. In one example, the wire 206 can be embodied as an insulated copper wire having an AWG value of 34 and a radius a of 80 μm, and thus, a diameter of 160 μm. The wire 206 can also have AWG values between 30-38, in other examples, and smaller or larger gauges can be relied upon in some cases. In addition, the wire 206 can extend to various lengths in the strain sensor 204 depending on the application. For instance, in a textile application or a safety rope application, the wire 206 can extent to a length of approximately 40-50 cm.

The core 208 can be embodied or implemented as a stretchable material formed at the center of the strain sensor 204. For instance, the core 208 can be embodied as an elastic material, such as a polyester elastic material. For example, the core 208 can be embodied as a polyester elastic string. In one example, the core 208 can be embodied as an elastic crystal string. As illustrated in FIG. 2, the core 208 can have a diameter d. The diameter d of the core 208 can vary depending on the application. In one example, the core 208 can have a diameter d of 1 mm. The diameter d of the core 208 can range in other examples, such as between 0.5-3 mm, including every diameter between 0.5 to 3 mm in increments of 0.1 mm, and larger or smaller diameters can be relied upon in some cases. Additionally, the core 208 can extend to various lengths depending on the application. For instance, in a textile application or a safety rope application, the core 208 can extend to a length of approximately 25-35 cm. In other examples, the core 208 can extend to a length of between 5-10 cm, between 10-15 cm, between 15-20 cm, between 20-25 cm, between 25-30 cm, between 30-35 cm, between 35-40 cm, between 40-45 cm, or between 45-50 cm, and other lengths can be used. Overall, the lengths of the wire 206 can depend on the length of the core 208. One or both ends of the wire 206 can be coupled or otherwise secured to the core 208 by a connector, such as an adhesive, similar to the connector 114 described above.

Due to the stretchable and bendable nature of the core 208, as well as the bendable or pliable characteristics of the wire 206, the strain sensor 204 many change or vary to some extent in direction (e.g., path of extension), size (e.g., length), shape, or related structural characteristics when external forces act upon the strain sensor 204, either directly or in connection with the object 202. As described below, changes to the structural characteristics of the strain sensor 204 will impart a change in the inductance of the strain sensor 204. These changes in the strain sensor 204 can be correlated to an amount of stress or strain applied to the strain sensor 204 and used in a range of sensory applications.

As illustrated in the example depicted in FIG. 2, the strain sensor system 200 can further include the LCR meter 116, the computing devices 118, 122, and the networks 120. The LCR meter 116 can be coupled (e.g., communicatively, electrically, operatively) to the strain sensor 204 by way of the wire 206. Particularly, the two ends of the wire 206 can be stripped of any insulating layer and electrically coupled to input terminals of the LCR meter 116. The LCR meter 116 can also be coupled (e.g., communicatively, electrically, operatively) to the computing device 118. Additionally, the computing device 118 can be coupled to (e.g., communicatively, operatively) the computing device 122 by way of the networks 120.

The LCR meter 116 can detect and measure a change in inductance associated with the wire 206 that can be caused by movement of the wire 206. For example, the change in inductance can be caused by movement of at least one helical turn of the wire 206 relative to at least one other helical turn of the wire 206. For instance, the LCR meter 116 can apply an electrical signal to the wire 206 while at least one of the object 202 or the strain sensor 204 is being moved in any direction or is otherwise subjected to external forces. As the object 202 and/or the strain sensor 204 moves, at least one of the winding pitch Λ or the winding angle θ corresponding to one or more sections of the wire 206 can change along at least some length of the strain sensor 204. Such a change in at least one of the winding pitch Λ or the winding angle θ in one or more sections of the wire 206 can alter the inductance associated with the wire 206. This inductance change can be detected and measured by the LCR meter 116. Further, this inductance change can correlate with and correspond to the extent of strain induced in at least one of the strain sensor 204 or the object 202 as a result of the movement of the strain sensor 204 and/or the object 202. More specifically, the strain can be a function of the inductance change that can be associated with the wire 206 as a result of moving at least one of the object 202 or the strain sensor 204. In one example, to detect and measure the inductance associated with the wire 206, the LCR meter 116 can be set to an alternating sense frequency of 100 kHz, although the change in inductance can be measured or characterized at other frequencies.

After detecting and measuring the above-described inductance change associated with the strain sensor 204, the LCR meter 116 can provide inductance change data to the computing device 118. The inductance change data can be indicative of the above-described inductance change that can be associated with the wire 206 as a result of moving at least one of the object 202 or the strain sensor 204. The computing device 118 can use the inductance change data to compute a corresponding strain value that can be indicative of and correspond to the strain induced in at least one of the strain sensor 204 or the object 202 as a result of the movement. It should be appreciated that the change in inductance of the strain sensor 204 can be independent of but correlated to a strain induced in at least one of the object 202 or the strain sensor 204 as a result of moving one or both of such components.

In some cases, the computing device 118 can perform one or more operations based on at least one of the above-described inductance change data or the corresponding strain value that can be obtained and computed by the computing device 118, respectively. In one example, the computing device 118 can monitor inductance change data provided by the LCR meter 116 that can be associated with the wire 206 as the object 202 and/or the strain sensor 204 move over time. The computing device 118 can further use such inductance change data to compute and monitor corresponding strains induced in at least one of the object 202 or the strain sensor 204 as a result of such movement over time. If the computing device 118 determines that one or more strain values induced in at least one of the object 202 or the strain sensor 204 exceed a defined strain threshold, the computing device 118 can, for instance, provide a warning notification in the same or similar manner as described above with reference to FIG. 1.

Although not illustrated in FIG. 2, in some cases, the strain sensor system 200 can include multiple strain sensors 204 that can be separately positioned at various locations along and/or around the object 202. Any or all of such strain sensors 204 can include a wire 206 wrapped in a helix pattern around a respective core 208. Additionally, any or all of such strain sensors 204 can be coupled (e.g., communicatively, electrically, operatively) to at least one of the LCR meter 116 or the computing device 118. Further, the LCR meter 116 can detect and measure respective inductance change data corresponding to any or all of such strain sensors 204 for a section or area of the object 202 in which they are respectively disposed. In this way, the strain sensor system 200 can facilitate monitoring of, for instance, the structural and mechanical integrity of the object 202 based on various inductance change data corresponding to any or all of the strain sensors 204. The strain sensor system 200 can thereby allow for a warning notification to be issued prior to failure of the object 202 due to stain values induced on the object 202 that exceed its strain limits.

In some examples, the computing device 118 can implement a model such as, for instance, an ML model, an AI model, or another model to determine a current state of the object 202 or to predict when the object 202 may potentially fail (e.g., rupture). For instance, the computing device 118 can implement such a model to determine the current mechanical or structural integrity of the object 202 based on at least one of the above-described inductance change data or corresponding strain values that can be obtained and computed by the computing device 118, respectively. In another example, the computing device 118 can implement at least one of an ML model, an AI model, or another model to predict the future mechanical or structural integrity of the object 202 based on at least one of such inductance change data or corresponding strain values. In this way, the computing device 118 can predict when the object 202 may potentially rupture.

In some cases, the computing device 118 can provide at least one of the above-described inductance change data, corresponding strain values, or warning notification to the computing device 122 by way of the networks 120. As described above with reference to FIG. 1, the computing device 122 can implement one or more aspects of the present disclosure. For example, in some cases, the computing device 118 can offload at least some of its processing workload to the computing device 122 via the networks 120.

In one example, the computing device 118 can use the networks 120 to send the computing device 122 the above-described inductance change data that can be associated with the wire 206 as a result of the object 202 and/or the strain sensor 204 moving over time. The computing device 122 can then use such inductance change data to compute and monitor corresponding strains induced in at least one of the object 202 or the strain sensor 204 as a result of such movement over time. If the computing device 122 determines that one or more strain values induced in at least one of the object 202 or the strain sensor 204 exceed a defined strain threshold, the computing device 122 can, for instance, provide the warning notification described above. In one example, the computing device 122 can provide such a warning notification in the same or similar manner as described above with reference to FIG. 1.

In another example, the computing device 118 can use the networks 120 to send the computing device 122 at least one of the above-described inductance change data or corresponding strain values that can be obtained and computed by the computing device 118, respectively. The computing device 122 can then use such inductance change data and/or corresponding strain values to implement a model such as, for instance, an ML model, an AI model, or another model to determine a current state of the object 202 or to predict when the object 202 may potentially fail (e.g., rupture). For instance, the computing device 122 can implement such a model to determine the current mechanical or structural integrity of the object 202 based on such inductance change data and/or corresponding strain values. In another example, the computing device 122 can implement at least one of an ML model, an AI model, or another model to predict the future mechanical or structural integrity of the object 202 based on at least one of such inductance change data or corresponding strain values. In this way, the computing device 122 can predict when the object 202 may potentially rupture.

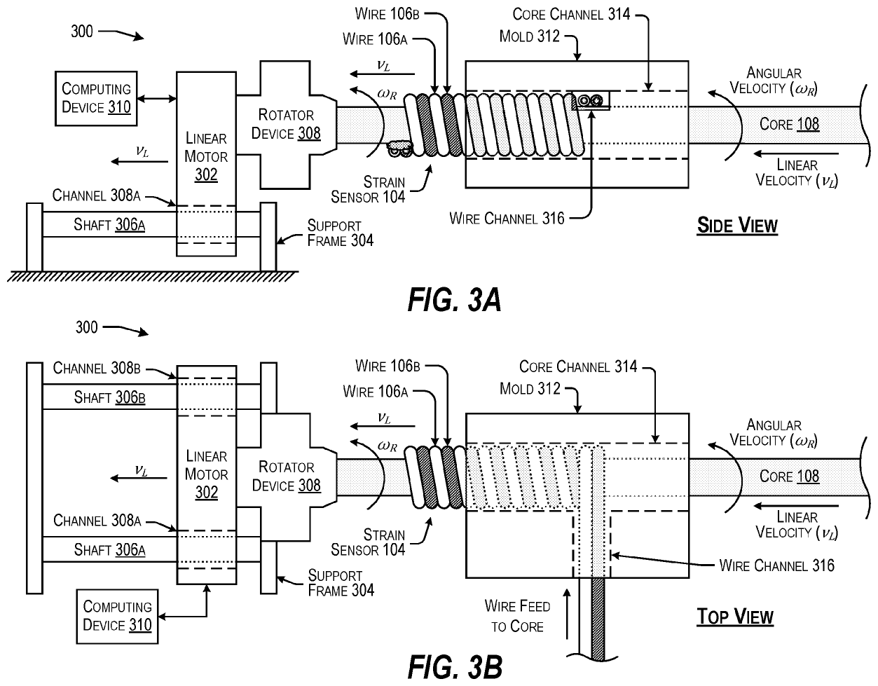

FIG. 3A illustrates a side view of an example fabrication system 300 according to at least one embodiment of the present disclosure. FIG. 3B illustrates a top view of the fabrication system 300 according to at least one embodiment of the present disclosure. The fabrication system 300 can be implemented to construct at least one of the strain sensor 104 or the strain sensor 204 according to at least one example described herein. Although the example depicted in FIGS. 3A and 3B illustrates the fabrication of the strain sensor 104 using the wires 106a, 106b and the core 108, the description below and the illustrations depicted in FIGS. 3A and 3B can also be used to fabricate the strain sensor 204 using the wire 206 and the core 208.

Referring among FIGS. 3A and 3B, the fabrication system 300 includes a linear motor 302 or linear actuator that can be mounted on a support frame 304. As illustrated in FIGS. 3A and 3B, the linear motor 302 can be mounted on the support frame 304 by way of two shafts 306a, 306b that are coupled to the support frame 304. The shafts 306a, 306b can respectively pass through two channels 308a, 308b in the linear motor 302. The linear motor 302 can be operable and configured to travel back and forth in a linear direction along the shafts 306a, 306b of the support frame 304. The fabrication system 300 also includes a rotator device 308 that is mechanically coupled to the linear motor 302. The linear motor 302 and the rotator device 308 can both, collectively, travel back and forth in a linear direction along the shafts 306a, 306b of the support frame 304 at a certain linear velocity ν_{L}. Additionally, the rotator device 308 can rotate at a certain angular velocity ω_{R} while the linear motor 302 and the rotator device 308 travel along the shafts 306a, 306b of the support frame 304 at the linear velocity ν_{L}. In one example, the rotator device 308 can rotate at a certain constant angular velocity ω_{R} while the linear motor 302 and the rotator device 308 travel along the shafts 306a, 306b of the support frame 304 at a certain constant linear velocity ν_{L}. In some cases, the angular velocity ω_{R}, the linear velocity ν_{L}, or both are maintained constant during fabrication of a strain sensor. In other cases, the angular velocity ω_{R}, the linear velocity ν_{L}, or both can be varied during fabrication of a strain sensor.

The fabrication system 300 can further include a computing device 310 that can be coupled (e.g., communicatively, electrically, operatively) to at least one of the linear motor 302 or the rotator device 308. The computing device 310 can be embodied or implemented as, for example, a client computing device, a peripheral computing device, or both. The computing device 310, while described in the singular, may include a collection of computing devices 310. Examples of the computing device 310 can include at least one of a computer, a general-purpose computer, a special-purpose computer, a laptop, a tablet, a smartphone, or another client computing device. The computing device 310 can be operable and configured to control at least one of the linear velocity ν_{L} of the linear motor 302 and the rotator device 308 or the angular velocity ω_{R} of the rotator device 308.

Further, as illustrated in the example depicted in FIGS. 3A and 3B, the fabrication system 300 can also include a mold 312. The mold 312 can have a core channel 314 passing through the mold 312 from one end or side of the mold 312 to another, opposite side or end of the mold 312. The core channel 314 can be formed such that it can support and guide the core 108 through the mold 312. Additionally, the core channel 314 can also support and guide the strain sensor 104 through the mold 312 after the wires 106a, 106b have been wrapped around the core 108 as shown in FIGS. 3A and 3B. The mold 312 can further include a wire channel 316 that can pass through the mold 312 and intersect the core channel 314 at, for instance, a 90° right angle as illustrated in FIG. 3B. In some cases, the wire channel 316 can intersect the core channel 314 at an angle other than a 90° right angle. In one example, the mold 312 can be formed using a polycarbonate (PC) material, although other materials can be relied upon. The core channel 314 can be formed at a suitable dimension to permit the core 108 or the core 208 to pass through it. The core channel 314 can be formed such that it has at least one of a width or a height (or a diameter) of between 1.5 mm-2.5 mm. The wire channel 316 can be formed at a suitable dimension to permit one or more wires, such as the wires 106a, 106b or the wire 206 to pass through it. In one example, the wire channel 316 can be formed such that it has at least one of a width or a height of approximately 0.5 mm-1 mm.

Although not depicted in FIGS. 3A and 3B, in some cases, the mold 312 can include a top portion and a bottom portion. Each of the top portion and the bottom portion can have at least part of each of the core channel 314 and the wire channel 316 formed therein. For instance, a bottom surface of the top portion of the mold 312 can include a first half of the depth of each of the core channel 314 and the wire channel 316 formed therein. In this example, a top surface of the bottom portion of the mold 312 can include a second half of the depth of each of the core channel 314 and the wire channel 316 formed therein. When the bottom surface of the top portion of the mold 312 is positioned on the top surface of the bottom portion of the mold 312, the portions of the core channel 314 and the wire channel 316 formed on the bottom surface of the top portion and on the top surface of the bottom portion can respectively align with one another. In this way, when the bottom surface of the top portion of the mold 312 is positioned on the top surface of the bottom portion of the mold 312, the core channel 314 and the wire channel 316 can thereby be completely formed in the mold 312.

The example embodiment of the mold 312 described above allows for removal (i.e., the separation) of the top portion of the mold 312 from the bottom portion of the mold 312, to position the wires 106a, 106b and the core 108 in the portions of the core channel 314 and the wire channel 316 formed in the top surface of the bottom portion of the mold 312. Once the wires 106a, 106b and the core 108 are positioned in such portions of the core channel 314 and the wire channel 316 formed in the top surface of the bottom portion of the mold 312, the bottom surface of the top portion of the mold 312 can be positioned on the top surface of the bottom portion of the mold 312.

To fabricate the strain sensor 104 using the fabrication system 300, one end of the core 108 can be coupled (e.g., mechanically) to the rotator device 308 while the other end of the core 108 can remain free and uncoupled. Also, one end of each of the wires 106a, 106b can be coupled (e.g., mechanically) to at least one of the core 108 via the connector 114 as shown in FIG. 3A or to the rotator device 308, which is not depicted in FIGS. 3A and 3B for clarity. The other end of each of the wires 106a, 106b can remain free and uncoupled. A spool of the core 108 can be positioned off the page to the right, for example, and fed through the core channel 314 of the mold 312. A spool or spools of the wires 106a, 106b can be positioned off and below the page, for example, and fed through the wire channel 316 of the mold 312.

Once one end of the core 108 is coupled to the rotator device 308, one end of each of the wires 106a, 106b is coupled to at least one of the core 108 or the rotator device 308, and the components are positioned in the mold 312, the computing device 310 can then employ the linear motor 302 and the rotator device 308 to fabricate the strain sensor 104. More specifically, the computing device 310 can cause the linear motor 302 and the rotator device 308 to move away from the mold 312 by traveling along the shafts 306a, 306b of the support frame 304 at the linear velocity ν_{L} while also causing the rotator device 308 to rotate at the angular velocity ω_{R}. As the rotator device 308 rotates, the core 108 is rotated and also pulled through the mold 312 via the linear motor 302. At the same time, the wires 106a, 106b are wrapped around the core 108 at the intersection of the core channel 314 and the wire channel 316 as illustrated in FIG. 3B. In this way, the fabrication system 300 can be implemented in a “batch” type process to fabricate the strain sensor 104 such that it has a defined length.

To more precisely control the winding pitch Λ, the wires 106a, 106b can be wound around the core 108 in a parallel and gapless fashion. Additionally, the 90° right angle at the intersection of the core channel 314 and the wire channel 316 can allow for the wires 106a, 106b to be wrapped around the core 108 at a 90° right angle during the winding process. The resulting winding pitch Λ can be defined as:

$$Λ = \frac{2 π}{{ω}_{R}} {v}_{L} \qquad Equation ( 1 )$$

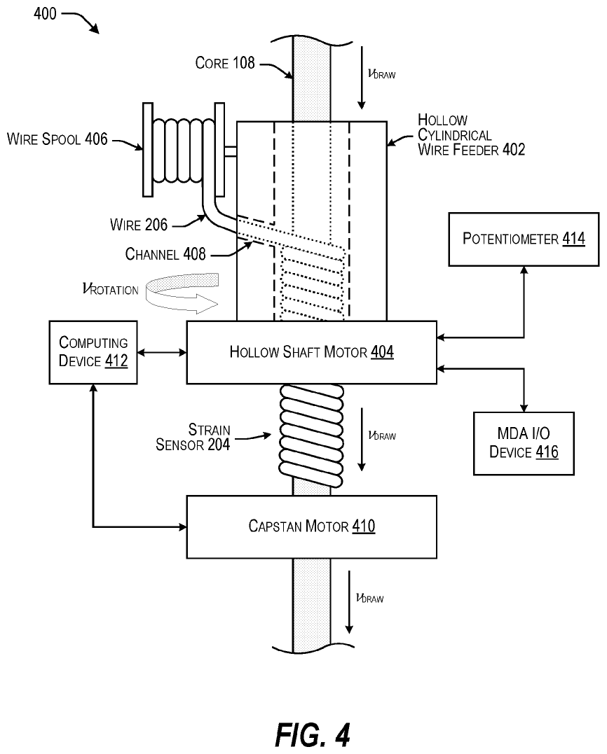

The fabrication system 300 can provide partial scalability through a “pause and step back” process. For example, such partial scalability can be achieved by using the computing device 310 to pause the linear movement of the linear motor 302 and the rotator device 308, as well as the rotation of the rotator device 308. Once paused, the computing device 310 can then cause the linear motor 302 and the rotator device 308 to return to their original position, that is, closer to the mold 312. Once the linear motor 302 and the rotator device 308 are returned to their original position, the computing device 310 can then cause the linear motor 302 and the rotator device 308 to re-start the winding of the wires 106a, 106b onto the core 108. To achieve full scalability automatically (e.g., without human intervention), the fabrication system 400 described below and depicted in FIG. 4 can be implemented. In some cases, the fabrication system 400 can be implemented to mimic a draw tower used in a thermal drawing process.

FIG. 4 illustrates another example fabrication system 400 according to at least one embodiment of the present disclosure. The fabrication system 400 can be implemented to construct at least one of the strain sensor 104 or the strain sensor 204 according to at least one example described herein. Although the example depicted in FIG. 4 illustrates the fabrication of the strain sensor 204 using the wire 206, the description below and the illustration depicted in FIG. 4 can also be used to fabricate the strain sensor 104 using the wires 106a, 106b.

The fabrication system 400 can include a hollow cylindrical wire feeder 402 that can be coaxially coupled (e.g., mechanically) to a hollow shaft motor 404. The hollow cylindrical wire feeder 402 can include a wire spool 406 that can be coupled (e.g., mechanically) to a surface such as, for example, a side surface of the hollow cylindrical wire feeder 402. In some cases, the hollow cylindrical wire feeder 402 can include multiple wire spools 406 that can be coupled to one or more surfaces such as, for example, a side surface or a top surface of the hollow cylindrical wire feeder 402. The wire spool 406 can include the wire 206 and it can spin freely to allow the wire 206 to be drawn (e.g., pulled) from the wire spool 406. The hollow cylindrical wire feeder 402 can also include a channel 408 that can be formed through, for instance, a side of the hollow cylindrical wire feeder 402 as illustrated in FIG. 4. The channel 408 can extend through the side of the hollow cylindrical wire feeder 402 and intersect with the hollow cylindrical center of the hollow cylindrical wire feeder 402. In this way, the wire 206 can be fed through the channel 408 and into the hollow cylindrical center of the hollow cylindrical wire feeder 402 where it can be wrapped around the core 108 as described below.

As illustrated in the example depicted in FIG. 4, the fabrication system 400 can further include a computing device 412, a capstan motor 410, a potentiometer 414, and a multifunctional data acquisition (MDA) input/output (I/O) device 416 (denoted as “MDA I/O device 416” in FIG. 4). The computing device 412 can be coupled (e.g., communicatively, electrically, operatively) to at least one of the hollow shaft motor 404 or the capstan motor 410. The potentiometer 414 and the MDA I/O device 416 can be coupled (e.g., communicatively, electrically, operatively) to the hollow shaft motor 404.

The computing device 412 can be embodied or implemented as, for example, a client computing device, a peripheral computing device, or both. The computing device 412, while described in the singular, may include a collection of computing devices 412. Examples of the computing device 412 can include at least one of a computer, a general-purpose computer, a special-purpose computer, a laptop, a tablet, a smartphone, or another client computing device. The computing device 412 can be operable and configured to control at least one of a rotation speed νᵣₒₜₐₜᵢₒₙ of the hollow shaft motor 404 or a draw speed ν_{draw} of the capstan motor 410.

To fabricate the strain sensor 204 using the fabrication system 400, the capstan motor 410 can pull the core 108 in a downward direction (i.e., toward the hollow cylindrical wire feeder 402) at a certain draw speed ν_{draw}. The capstan motor 410 can pull the core 108 downward at the draw speed ν_{draw} while also preventing the core 108 from rotating about its axis. Further, the capstan motor 410 can pull the core 108 through the hollow centers of the hollow cylindrical wire feeder 402 and the hollow shaft motor 404. As the capstan motor 410 pulls the core 108 downward through the hollow center of the hollow cylindrical wire feeder 402 and the hollow shaft motor 404, the hollow shaft motor 404 can rotate at a certain rotation speed νᵣₒₜₐₜᵢₒₙ to draw the wire 206 from the wire spool 406 and into the hollow cylindrical wire feeder 402. Once inside the hollow cylindrical wire feeder 402, the wire 206 can be wrapped around the core 108 based on the rotation of the hollow shaft motor 404 at the rotation speed νᵣₒₜₐₜᵢₒₙ. In this way, the wire 206 can be wrapped around the core 108 in a helical pattern to create the strain sensor 204 such that it has a helical structure formed with the wire 206.

The rotation speed νᵣₒₜₐₜᵢₒₙ of the hollow shaft motor 404 can be controlled by a voltage or other type of control signal. In one example, the voltage applied to the hollow shaft motor 404 can be controlled by the computing device 412. In another example, the voltage applied to the hollow shaft motor 404 can be controlled directly by the potentiometer 414. In still another example, the voltage applied to the hollow shaft motor 404 can be controlled in a programable fashion using the multifunctional data acquisition (MDA) input/output (I/O) device 416.

In one example, the voltage applied to the hollow shaft motor 404 can be approximately 0.1-5 volts (V). In another example, the maximum rotation speed νᵣₒₜₐₜᵢₒₙ of the hollow shaft motor 404 can be, for instance, 6,000 revolutions per minute (RPM). In yet another example, the draw speed ν_{draw} of the capstan motor 410 can range between, for instance, approximately 0.001 meter per min (m/min) to 60 m/min. In a steady drawing process, the winding pitch Λ can be defined as:

$$Λ = \frac{{v}_{draw}}{{v}_{rotation}} \qquad Equation ( 2 )$$

By tuning at least one of the rotation speed νᵣₒₜₐₜᵢₒₙ or the draw speed ν_{draw}, various helical structures can be fabricated based on various winding pitches A. Moreover, the fabrication system 400 can eliminate the rotation of the core 108 as described above, and thus can allow for soft materials with relatively high stretchability to be used as the core 108. Additionally, the fabrication system 400 can be implemented to achieve scalability automatically.

In some cases, the hollow shaft motor 404 can also be combined with extrusion and melt spinning processes to fabricate at least one of the strain sensor 104 or the strain sensor 204 using, for instance, fibers or yarns. For example, the hollow shaft motor 404 can be combined with extrusion and melt spinning processes to fabricate at least one of the strain sensor 104 or the strain sensor 204 using, for instance, pure thermoplastic materials, composite polymer materials with or without elasticity, or another material.

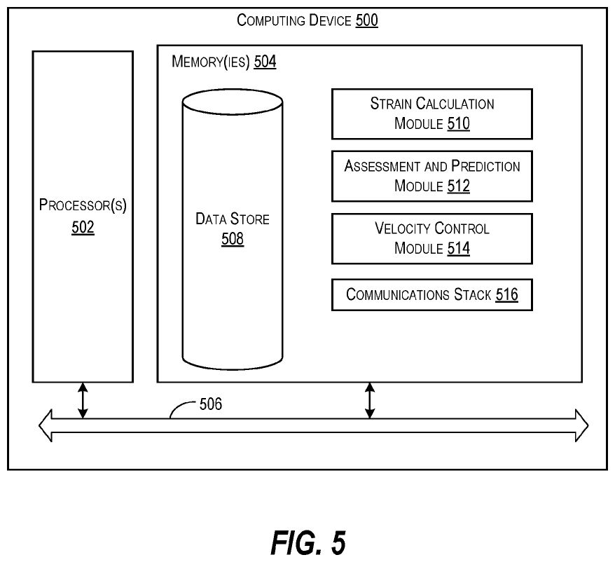

FIG. 5 illustrates a block diagram of an example computing device 500 according to at least one embodiment of the present disclosure. With reference to FIGS. 1 and 2 collectively, the computing device 500 can be used, at least in part, to embody or implement one or more components of at least one of the strain sensor system 100, the strain sensor system 200, the fabrication system 300, or the fabrication system 400. In one example, the computing device 500 can be used, at least in part, to embody or implement at least one of the computing device 118, 122, 310, or 412.

The computing device 500 can include at least one processing system, for example, having at least one processor 502 and at least one memory 504, both of which can be coupled (e.g., communicatively, electrically, operatively) to a local interface 506. The memory 504 can include a data store 508, a strain calculation module 510, an assessment and prediction module 512, a velocity control module 514, and a communications stack 516 in the example shown. The computing device 500 can also include other components that are not illustrated in FIG. 5. In some cases, the computing device 500, the computing device 500, or both may or may not include all the components illustrated in FIG. 5. For example, in some cases, depending on how the computing device 500 is embodied or implemented, the memory 504 may or may not include at least one of the strain calculation module 510, the assessment and prediction module 512, the velocity control module 514, or other components.

The processor 502 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 502 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 504 can be embodied as one or more memory devices and store data and software or executable-code components executable by the processor 502. For example, the memory 504 can store executable-code components associated with the strain calculation module 510, the assessment and prediction module 512, the velocity control module 514, and the communications stack 516 for execution by the processor 502. The memory 504 can also store data such as the data described below that can be stored in the data store 508, among other data. For instance, the memory 504 can also store at least one of the capacitance or inductance change data described above with reference to FIGS. 1 and 2 or the strain values corresponding to such capacitance or inductance change data.

The memory 504 can store other executable-code components for execution by the processor 502. For example, an operating system can be stored in the memory 504 for execution by the processor 502. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 504 can store software for execution by the processor 502. In this respect, the terms “executable” or “for execution” refer to software forms that can ultimately be run or executed by the processor 502, whether in source, object, machine, or other form. Examples of executable programs include, for instance, a compiled program that can be translated into a machine code format and loaded into a random access portion of the memory 504 and executed by the processor 502, source code that can be expressed in an object code format and loaded into a random access portion of the memory 504 and executed by the processor 502, source code that can be interpreted by another executable program to generate instructions in a random access portion of the memory 504 and executed by the processor 502, or other executable programs or code.

The local interface 506 can be embodied as a data bus with an accompanying address/control bus or other addressing, control, and/or command lines. In part, the local interface 506 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 508 can include data for the computing device 500 such as, for instance, one or more unique identifiers for the computing device 500, digital certificates, encryption keys, session keys and session parameters for communications, and other data for reference and processing. The data store 508 can also store computer-readable instructions for execution by the computing device 500 via the processor 502, including instructions for the strain calculation module 510, the assessment and prediction module 512, the velocity control module 514, and the communications stack 516. In some cases, the data store 508 can also store at least one of the capacitance or inductance change data described above with reference to FIGS. 1 and 2 or the strain values corresponding to such capacitance or inductance change data.

The strain calculation module 510 can be embodied or implemented as one or more software applications or services executing on the computing device 500. The strain calculation module 510 can be executed by the processor 502 to compute one or more strain values respectively corresponding to at least one of the object 102, the object 202, the strain sensor 104, or the strain sensor 204. In one example, the strain calculation module 510 can be implemented to compute strain values corresponding to the object 102 and/or the strain sensor 104 based on the above-described capacitance change data that can be associated with the wires 106a, 106b as a result of moving at least one of the object 102 or the strain sensor 104. In another example, the strain calculation module 510 can be implemented to compute strain values corresponding to the object 202 and/or the strain sensor 204 based on the above-described inductance change data that can be associated with the wire 206 as a result of moving at least one of the object 202 or the strain sensor 204.

The assessment and prediction module 512 can be embodied or implemented as one or more software applications or services executing on the computing device 500. The assessment and prediction module 512 can be executed by the processor 502 to determine a current mechanical or structural state of at least one of the object 102 or the object 202. The assessment and prediction module 512 can also be executed by the processor 502 to predict when at least one of the object 102 or the object 202 may potentially fail (e.g., rupture).

In one example, the assessment and prediction module 512 can implement at least one of an ML model, an AI model, or another model to determine the current mechanical or structural integrity of the object 102 based on at least one of the above-described capacitance change data or corresponding strain values that can be obtained and computed by the computing device 118 (e.g., using the strain calculation module 510), respectively. Additionally, the assessment and prediction module 512 can implement such a model to predict the future mechanical or structural integrity of the object 102 based on at least one of such capacitance change data or corresponding strain values. In this way, the assessment and prediction module 512 can predict when the object 102 may potentially rupture.

In another example, the assessment and prediction module 512 can implement at least one of an ML model, an AI model, or another model to determine the current mechanical or structural integrity of the object 202 based on at least one of the above-described inductance change data or corresponding strain values that can be obtained and computed by the computing device 118 (e.g., using the strain calculation module 510), respectively. Additionally, the assessment and prediction module 512 can implement such a model to predict the future mechanical or structural integrity of the object 202 based on at least one of such inductance change data or corresponding strain values. In this way, the assessment and prediction module 512 can predict when the object 202 may potentially rupture.

The velocity control module 514 can be embodied or implemented as one or more software applications or services executing on the computing device 500. The velocity control module 514 can be executed by the processor 502 to control at least one of the linear velocity ν_{L} of the linear motor 302 and the rotator device 308, the angular velocity ω_{R} of the rotator device 308, the draw speed ν_{draw}, of the capstan motor 410, or the rotation speed νᵣₒₜₐₜᵢₒₙ of the hollow shaft motor 404. In this way, the velocity control module 514 can be implemented to fabricate at least one of the strain sensor 104 or the strain sensor 204 such that one or both have a helical structure with a certain winding pitch Λ and/or winding angle θ.

The communications stack 516 can include software and hardware layers to implement data communications such as, for instance, Bluetooth®, Bluetooth® Low Energy (BLE), WiFi®, cellular data communications interfaces, or a combination thereof. Thus, the communications stack 516 can be relied upon by at least one of the computing device 118, 122, 310, or 412 to establish cellular, Bluetooth®, WiFi®, and other communications channels with the networks 120 and with one another.

The communications stack 516 can include the software and hardware to implement Bluetooth®, BLE, and related networking interfaces, which provide for a variety of different network configurations and flexible networking protocols for short-range, low-power wireless communications. The communications stack 516 can also include the software and hardware to implement WiFi® communication, and cellular communication, which also offers a variety of different network configurations and flexible networking protocols for mid-range, long-range, wireless, and cellular communications. The communications stack 516 can also incorporate the software and hardware to implement other communications interfaces, such as X10®, ZigBee®, Z-Wave®, and others. The communications stack 516 can be configured to communicate various data to and from at least one of the computing device 118, 122, 310, or 412. For example, the communications stack 516 can be configured to allow for the computing devices 118, 122 to share at least one of the above-described capacitance or inductance change data, the strain values corresponding to such capacitance or inductance change data, the warning notification, or other data.

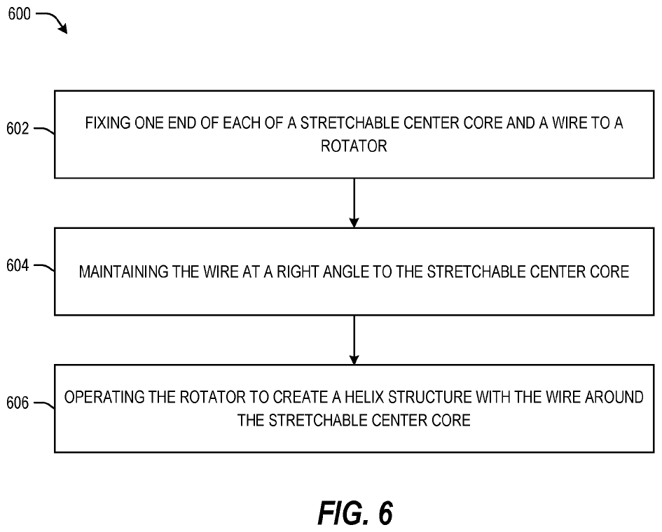

FIG. 6 illustrates a flow diagram of an example computer-implemented method 600 that can be implemented to fabricate a strain sensor according to at least one embodiment of the present disclosure. In one example, the computer-implemented method 600 (hereinafter, “the method 600”) can be implemented by at least one of the computing device 118, 122, 310, or 412. The method 600 can be implemented in the context of at least one of the strain sensor system 100, the strain sensor system 200, the fabrication system 300, or the fabrication system 400. In one example, the method 600 can be implemented to perform one or more of the operations described herein with reference to the examples depicted in FIGS. 1, 2, 3A, 3B, 4, and 5.

At 602, the method 600 can include fixing one end of each of a stretchable center core and a wire to a rotator. For example, as described above with reference to FIGS. 3A and 3B, one end of each of the wires 106a, 106b and one end of the core 108 can be coupled (e.g., mechanically) to the rotator device 308.

At 604, the method 600 can include maintaining the wire at a right angle to the stretchable center core. For example, as described above with reference to FIGS. 3A and 3B and as illustrated in FIG. 3B, the core channel 314 and the wire channel 316 of the mold 312 can be formed such that they intersect at a 90° right angle. In this way, the wires 106a, 106b can be maintained at a 90° right angle with respect to the core 108 while the core 108 is being pulled through the core channel 314 and the wires 106a, 106b are being pulled through the wire channel 316.

At 606, the method 600 can include operating the rotator to create a helix structure with the wire around the stretchable center core. For example, as described above with reference to FIGS. 3A and 3B, the computing device 310 can cause the linear motor 302 and the rotator device 308 to travel away from the mold 312 along the shafts 306a, 306b of the support frame 304 at the linear velocity ν_{L}. The computing device 310 can further cause the rotator device 308 to rotate at the angular velocity ω_{R} while the linear motor 302 and the rotator device 308 are traveling away from the mold 312 along the shafts 306a, 306b of the support frame 304 at the linear velocity ν_{L}. In this way, the computing device 310 (e.g., via the linear motor 302 and the rotator device 308) can cause the wires 106a, 106b to be wrapped around the core 108 at the intersection of the core channel 314 and the wire channel 316, thereby creating a double helix structure with the wires 106a, 106b around the core 108.

Referring now to FIG. 5, an executable program can be stored in any portion or component of the memory 504 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 504 can include both volatile and nonvolatile memory and data storage components. Volatile components are those that do not retain data values upon loss of power. Nonvolatile components are those that retain data upon a loss of power. Thus, the memory 504 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the strain calculation module 510, the assessment and prediction module 512, the velocity control module 514, and the communications stack 516 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 6, the flowchart or process diagram shown in FIG. 6 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 502. The machine code can be converted from the source code. Further, each block can represent, or be connected with, a circuit or a number of interconnected circuits to implement a certain logical function or process step.

Although the flowchart or process diagram shown in FIG. 6 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the strain calculation module 510, the assessment and prediction module 512, the velocity control module 514, and the communications stack 516 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 6. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referenced herein, the term “user” refers to at least one of a human, an end-user, a consumer, a computing device and/or program (e.g., a processor, computing hardware and/or software, an application), an agent, an ML and/or AI model, and/or another type of user that can implement and/or facilitate implementation of one or more embodiments of the present disclosure as described herein, illustrated in the accompanying drawings, and/or included in the appended claims. As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A flexible capacitive strain sensor, comprising:
a stretchable center core; and
two parallel wires wound about the stretchable center core, forming a double helix structure.

2. The flexible capacitive strain sensor of claim 1, wherein the stretchable center core comprises a polyester elastic string.

3. The flexible capacitive strain sensor of claim 2, wherein the polyester elastic string has a diameter of 1 millimeter (mm).

4. The flexible capacitive strain sensor of claim 1, wherein an angle between at least one of the two parallel wires and a cross-section of the stretchable center core is less than 45 degrees.

5. The flexible capacitive strain sensor of claim 1, wherein the two parallel wires comprise insulated copper wires that each have a diameter of 160 micrometers (μm).

6. The flexible capacitive strain sensor of claim 1, wherein the two parallel wires comprise one uninsulated copper wire and one insulated copper wire.

7. The flexible capacitive strain sensor of claim 1, wherein the two parallel wires are wound in a gapless fashion about the stretchable center core.

8. The flexible capacitive strain sensor of claim 1, wherein one end of each of the two parallel wires is coupled to the stretchable center core by an adhesive.

9. The flexible capacitive strain sensor of claim 1, wherein the flexible capacitive strain sensor is operable to respond to capacitance changes associated with the two parallel wires in a manner that is independent of a strain rate corresponding to a strain induced in the flexible capacitive strain sensor.

10. A flexible inductive strain sensor, comprising:
a stretchable center core; and
a single wire wound about the stretchable center core, forming a single helix structure.

11. The flexible inductive strain sensor of claim 10, wherein the stretchable center core comprises a polyester elastic string.

12. The flexible inductive strain sensor of claim 11, wherein the polyester elastic string has a diameter of 1 millimeter (mm).

13. The flexible inductive strain sensor of claim 10, wherein an angle between the single wire and a cross-section of the stretchable center core is less than 45 degrees.

14. The flexible inductive strain sensor of claim 10, wherein the single wire comprises an insulated copper wire having a diameter of 160 micrometers (μm).

15. The flexible inductive strain sensor of claim 10, wherein the single wire comprises an uninsulated copper wire.

16. The flexible inductive strain sensor of claim 10, wherein the single wire is wound in a gapless fashion about the stretchable center core.

17. A method for fabricating a flexible strain sensor, the method comprising:
fixing one end of each of a stretchable center core and at least one wire to a rotator;
maintaining the at least one wire at a right angle to the stretchable center core; and
operating the rotator to rotate the stretchable center core while pulling the stretchable center core in a linear direction to create a helix structure with the at least one wire around the stretchable center core.

18. The method of claim 17, wherein the at least one wire comprises two insulated wires, and wherein the method further comprises fixing one end of each of the two insulated wires to the stretchable center core with an adhesive.

19. The method of claim 17, wherein the right angle is maintained by a mold having a first channel to direct the at least one wire and a second channel to direct the stretchable center core, the first channel and the second channel intersecting at the right angle.

20. The method of claim 17, wherein the rotator is attached to a linear motor that causes the rotator to pull the stretchable center core in the linear direction.

21. A method for fabricating a flexible strain sensor, the method comprising:
feeding a stretchable center core through a center of a hollow cylindrical wire feeder and a center of a hollow shaft motor, the hollow cylindrical wire feeder being coaxially coupled to the hollow shaft motor;
feeding at least one wire through a side of the hollow cylindrical wire feeder to meet with the stretchable center core; and
operating the hollow shaft motor to create a helix structure with the at least one wire around the stretchable center core.

22. The method of claim 21, further comprising controlling a winding pitch based at least in part on controlling a first speed of the hollow shaft motor and a second speed of a capstan motor that feeds the stretchable center core through the center of the hollow cylindrical wire feeder and the center of the hollow shaft motor.

23. A flexible reactive strain sensor, comprising:
a stretchable center core; and
at least one wire wound about the stretchable center core, forming a helix structure.

24. The flexible reactive strain sensor of claim 23, wherein the stretchable center core comprises a polyester elastic string.

25. The flexible reactive strain sensor of claim 24, wherein the polyester elastic string has a diameter of 1 millimeter (mm).

26. The flexible reactive strain sensor of claim 23, wherein an angle between the at least one wire and a cross-section of the stretchable center core is less than 45 degrees.
